(19) United States
(12) Patent Application Publication
(10) Pub. No.: US 2007/0251365 A1
(43) Pub. Date: Nov. 1, 2007

(54) DIE CUTTER BLANKET

(75) Inventors: Kenneth Ray Neal, Magnolia, TX (US); Keith Seeley, Hackettstown, NJ (US)

Correspondence Address: CARELLA, BYRNE, BAIN, GILFILLAN, CECCHI,;STEWART & OLSTEIN, 5 BECKER FARM ROAD, ROSELAND, NJ, 07068, US

(73) Assignee: ROBUD, Pine Brook, NJ (US)

(21) Appl. No.: 11/738,141

(22) Filed: Apr. 20, 2007

Related U.S. Application Data
(60) Provisional application No. 60/745,904, filed on Apr. 28, 2006.

(51) Int. Cl. B26D 7/20

(52) U.S. Cl. 83/347; 83/659; 83/698.42

(57) ABSTRACT

A die cutter blanket assembly includes a plastic sheet material member and a sheet metal liner that has an array of preferably dome shaped dimples molded to the plastic sheet material member, the liner being attached to the member by bonding during the molding process. The dimples permit the plastic material to flow therebetween on a side of the liner opposite the sheet material member to encapsulate the liner with the plastic material as the liner and plastic sheet member are molded. The resulting blanket assembly is more flexible and easier to install on an anvil cylinder than prior blanket assemblies which comprise conventional flat metal liners without the encapsulation.

This application claims the benefit of application Ser. No. 60/745,904 filed Apr. 28, 2006 incorporated herein by reference in its entirety.

This invention relates to die cutter blankets used to cover rotating anvils in a sheet material die cutting apparatus.

Of interest are commonly owned U.S. Pat. Nos. 5,720,212; 6,668,694; 4,791,846; 4,982,639; 4,073,207; 4,073,208; 5,078,535; 5,916,346; 6,135,002 among others all related to die cutter blankets and related structures.

Other U.S. patents relating to die cutter blankets and related structures include U.S. Pat. Nos. 3,765,329; 4,191,076; 4,848,204; 4,867,024; and 5,076,128.

Die cutter blankets are thermoset molded urethane material that wrap about steel circular cylindrical anvils. The anvils typically have a channel in the surface thereof extending along the anvil longitudinal axis about which the anvil rotates. Some blanket embodiments include interlocking projections which depend into the anvil channel. These projections lock to the anvil channel for securing the blanket to the anvil. Some blankets have interlocking fingers at their abutting ends at the blanket outer work surface.

The blankets are typically thermoset molded sheet urethane material with opposing abutting end edges at which the interlocking projections are located. The ends are complementary with the locking projections engaging when the projections are inserted into the channel. The locking projections in some embodiments interlock with each other, locking the blanket to the anvil and preclude the blanket from rotating about the anvil.

These blankets are used with die cutting machines wherein a work piece such as a paper board or sheet corrugated paper is passed between the anvil-blanket arrangement and a die cutting roller. The dies, referred to as rules in this industry, on the die cutting roller pass through the work piece in different orientations to form slits or creases in products from the flat sheet material, The paper board sheet material is later folded to form a box or other product.

The thermoset molded urethane material forms a cover that is molded to a liner which is sheet material and which supports and reinforces the plastic cover material. The liners may be fabrics or sheet metal such as sheet steel. The liners are cast molded with the covers to form a unitary integral blanket assembly.

The blankets typically are about one foot in width. A plurality of blankets for example about eight, more or less, are wrapped about a rotatable steel cylindrical anvil in series on the anvil and attached in abutting relationship in a linear array along the anvil length parallel to the anvil axis of rotation. The blankets are typically attached via depending projections to an axially extending channel in the anvil surface. The blankets are attached manually. This means an installation person wraps the blanket about and attaches the blanket assembly to the anvil one at a time. This action requires one end of the blanket assembly to be secured to the anvil channel first and then the other end wrapped about the anvil cylinder and the free end then engaged with the one secured end and attached to and locked to the anvil channel and to the other end. The blanket-liner assembly is generally flat after molding and is an elongated sheet. To wrap the blanket requires one end with a depending projection to be first attached to the anvil. This is done by inserting the projection into an anvil channel to secure that one end to the anvil. The blanket assembly then has to be manually bent into a curved shape in order to wrap it about the anvil cylinder.

A problem noted by the present inventors with the above installation process is that it is relatively often difficult for a person to bend the blanket assembly as it is being wrapped about the anvil. The blanket assembly is stiff and difficult to bend. This makes the manual installation of the blanket assembly tedious, physically taxing on the installer and time consuming. Such installation time is costly in a system including a number of such blanket assemblies where the assemblies need to be frequently attached to an anvil to replace worn blanket assemblies creating undesired downtime for the die cutting machinery. A need is seen by the present inventors for a solution to this problem.

According to an embodiment of the present invention, the above-noted problem is minimized by a die cutter blanket assembly that comprises a die cutter plastic material sheet member having first and second ends. A sheet metal liner is bonded to the plastic sheet member and is substantially encapsulated by the plastic material. A locking arrangement is at the first and second ends for securing the blanket assembly to the anvil.

Surprisingly, the present inventors have discovered that the encapsulated sheet metal liner results in the blanket liner assembly being more flexible than the prior flat sheet metal liners which are not encapsulated and thus is easier to manually wrap about the cylindrical anvil minimizing installation fatigue of the installer and downtime.

In one embodiment, the liner includes a plurality of upstanding projections.

In a further embodiment, the projections are surrounded by the plastic material for substantially encapsulating the liner with the surrounding plastic material.

In a still further embodiment, the sheet member is urethane.

In a further embodiment, the projections are semispherical.

Preferably, the projections are dome shaped.

In a further embodiment, the projections are about ⅝ inches (about 16 mm) in diameter at their junction with the sheet metal liner and the projections are in the range of about 0.080 to 0.090 inches (2-2.3 mm) in height above the sheet metal liner.

Preferably, the projections are spaced apart center to center about two inches (50 mm) in a plurality of parallel rows each row comprising a linear array of projections.

In a further embodiment, the rows are spaced apart in the range of about two inches (50 mm) to about 3.5 inches (90 mm).

In a still further embodiment, the liner is about 0.017-0.021 inches thick sheet steel (0.4-0.5 mm).

in a further embodiment, the locking arrangement includes a locking device for locking engagement with the anvil channel.

In a further embodiment, the locking arrangement includes a projection for the locking engagement.

Preferably, the liner has opposite sides, the plastic material being present on both sides of the liner.

In a further embodiment, a method of making a die cutter blanket assembly for covering a rotatable cylindrical anvil of a die cutter apparatus according to the present invention comprises encapsulating a sheet metal blanket liner with a plastic material during the molding of a die cutter plastic sheet member, the molding for bonding the encapsulated liner to the plastic sheet member having first and second ends, and forming a locking arrangement at the first and second ends for locking the assembly to the anvil.

In a further embodiment, a die cutter blanket assembly is for covering a rotatable anvil of a die cutter apparatus, the anvil having a channel therein, the assembly comprising a plastic material sheet member having first and second ends, the member for wrapping about the anvil such that the ends abut one another in the wrapped state to form a substantially continuous outer work surface about the anvil. A sheet metal liner is bonded contiguous to and overlying the plastic sheet member, the liner having an array of spaced upstanding projections, the plastic material substantially encapsulating the liner. A locking arrangement is secured to the sheet material member at the first and second ends for securing the sheet material member and liner to the anvil.

### IN THE DRAWING

FIG. 1 is an isometric view of a blanket and anvil assembly illustrating an axial array of blankets attached to an anvil according to an embodiment of the present invention;

FIG. 2 is a fragmented sectional elevation view through one of the blankets of FIG. 1 in the typical flat uninstalled state showing the liner and molded plastic sheet blanket material;

FIG. 3 is a sectional elevation view of the mating locked abutting ends of a representative blanket assembly attached to the anvil as employed in the embodiment of FIG. 1;

FIG. 4 is a top plan view of the dimpled sheet metal liner that is attached to the blanket assemblies of FIGS. 2 and 3;

FIG. 5 is a top plan view of one of the dimples of the liner of FIG. 4 taken at region 5;

FIG. 6 is a a sectional elevation view of the liner of FIG. 5 taken at lines 6-6; and

FIG. 7 is a fragmented sectional elevation view of the liner in a mold for molding the blanket-liner assembly.

In the drawings, preferred embodiments of the present invention are illustrated wherein like parts are designated with like reference numerals. These drawings are diagrammatic and actual parts may differ from the drawings in scale and shape.

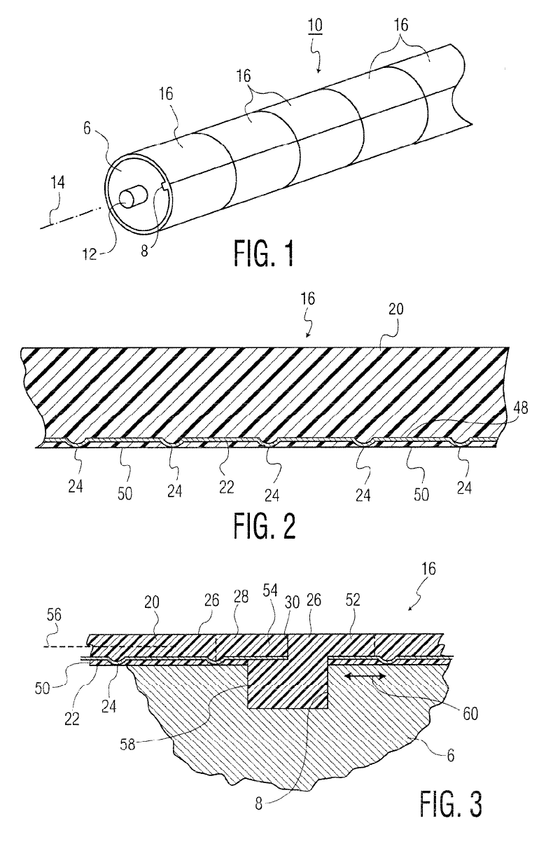

In FIG. 1, anvil and blanket assembly 10 comprises a steel circular cylindrical die cutter anvil 6 that has an axially extending channel 8 in the surface thereof for the length of the anvil. The anvil is rotated about longitudinal axis 14 by an apparatus (not shown) via an anvil shaft 12.

Attached to the anvil 6 is an axial array of blanket-liner assemblies 16. In FIG. 2, representative blanket assembly 16 comprises a plastic thermoset molded sheet material die cutter member 20 attached to a steel sheet liner 22. The liner 22 is of conventional sheet steel as used in this art. The liner 22 is molded to the member 20 in a conventional molding apparatus (not shown) such that the member 20 is adheringly bonded to the liner. The liner 22 has an array of stamped upstanding dimples 24 forming an array of convex-concave dome shaped projections.

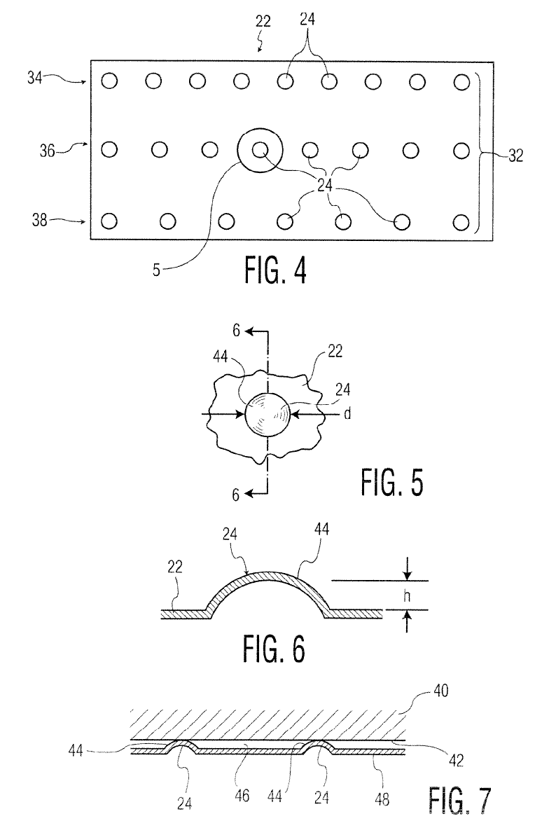

In FIG. 4, the liner 22 is elongated and rectangular. The length (left to right in the figure) and width (top to bottom of the figure) of the liner matches that of the cover 20. The length is sufficient for the blanket assembly 16 to wrap about the anvil 6 and lock to the anvil channel 8 in a conventional manner. When so wrapped the edges of the respective ends 26, 28 of the blanket assembly 16 abut at seam 30, FIG. 3, to form a continuous smooth die cutting outer work surface 26. The width of the representative blanket assembly 16 is generally about a foot (30.5 cm).

In FIG. 4, the liner 22 has an array 32 of the dimples 24. The dimples 24 are identical in this embodiment, but may differ from each other in other implementations. The array 32 comprises an array of three rows 34, 36 and 38 of dimples 24. The dimples 24 in each of the three rows are equally spaced from each other in the corresponding row in this embodiment, but may have different spacing in other embodiments. The spacing between dimples in all of the rows is preferably the same. The spacing between the rows may differ. The dimples are preferably identical, but they may differ in dimension and shape in other embodiments. Also the dimples while convex-concave dome shaped in this embodiment, may have other shapes such as polygon, cubic triangular and so on as long as the shape of the dimples permits the plastic material to flow around and full encapsulate the liner during molding as described below The volumes contained by the dimples may also be of different values and shapes in different sheet metal liners and also may differ from each other in a given liner as long as the liner becomes encapsulated during molding of the blanket assembly. There is no criticality in size or shape of the dimples 24 except to permit the plastic material during molding to flow around the dimples to encapsulate the liner 22 as described below.

In FIGS. 5 and 6, preferably the dimples 24 are circular semi-spherical dome shaped as shown. The dimples 24 preferably have a representative maximum outer diameter d at their base regions, FIG. 5, of about ⅝ inches (about 16 mm) and an external height h of their convex domes above the surrounding liner surface plane, FIG. 6, of about 0.08 to about 0.09 inches (about 2 mm to about 2.3 mm). However, these dimensions are given by way of example for the disclosed embodiment and may vary from these values in other embodiments. The liner 22 preferably is sheet steel having a thickness of about 0.017-0.021 inches (0.4-0.5 mm). The dimples have smooth outer convex and inner concave spherical surfaces to permit the plastic material to readily flow around the dimples without gaps.

In FIG. 7, a portion of a mold 40 is shown having an interior mold surface 42. In the prior art molding of the liner blanket assemblies, the sheet metal liner is positioned abutting the mold surface 42 with no spacing therebetween. As a result no plastic material is permitted to flow between the liner and the mold surface 42. However, as shown in FIG. 7, the upstanding outer convex surface 44 of the dimples 24 of the liner 22 abut the mold inner surface 42. This abutment of the dimples against the surface 42 of the mold 40 creates a gap 46 between the liner 22 and the mold surface 42.

During the molding process when the plastic sheet die cutter member 20 is being molded, the molten plastic material in the mold is able to flow into the gap 46 between the liner 22 and the mold surface 42. Thus plastic material forming the member 20 is contiguous with the liner on the liner surface 48, FIG. 7, and a portion of the plastic material flows into the gap 46 between the liner 22 and the mold surface 46 to form a plastic layer 50, FIG. 2. The plastic layer 50 covers substantially all of the outer surface of the liner encapsulating the liner in combination with the molded plastic sheet member 20. While some plastic material may not fully cover some or all of the dimples, this is acceptable. The layer 50 in practice almost fully if not entirely, covers the liner to encapsulate it.

Applicants have discovered that by encapsulating the liner with the plastic material layer 50 and with the molded member 20, the molded member 20 and liner 22 assembly exhibit greater bending flexibility than an assembly molded without the layer 50 and without the encapsulation as in the prior art. This greater flexibility permits an installation person to more easily bend the blanket assembly 16 when wrapping it about and securing it to the anvil. This results in less fatigue of the installer and a quicker installation than with prior art blanket assemblies.

Thus the shape, dimensions, spacing of the projections permitting the encapsulation of the liner to the sheet member 20 is only important to the extent that the liner can be encapsulated during the molding process and does not have such molding defects that would interfere with the operation of the blanket assembly or its life. The present inventors do not contemplate any particular shape, size or configuration of the projections that would so detract from the operation or life of the blanket assembly.

In FIG. 3, anvil 6 has channel 8 as described above. Blanket assembly 16 is arranged with interlocking fingers 52 and 54 which lie in the plane 56 of the blanket and coextensive therewith. Such fingers are shown for example in U.S. Pat. No. 4,791,846 incorporated by reference herein. However, in this patent movement is permitted between the blanket and the anvil head during operation In the present embodiment such relative movement is not desired.

To lock the blanket assembly 16 in place to preclude relative movement to the anvil 6, a locking projection 58 depends from end 26 of assembly 16. The projection 58 depends from the fingers 52 and 54. The projection is integral with and is one piece with the blanket sheet member 20. The projection 58 is of the same shape as the channel 8 and extends for the length of the channel 8 into and out of the drawing figure. The projection 58 is dimensioned to fit in interference compressible friction engagement fit with the channel 8 in the transverse directions 60. This fit locks the projection 58 and the blanket assembly 16 to the anvil 6 precluding axial displacement of the blanket assembly 16 relative to the anvil 6.

It will occur to one of ordinary skill in this art that various modifications may be made to the disclosed preferred embodiments without departing from the spirit and scope of the invention. For example, the shape and dimensions of the dimples and of the sheet metal liner may differ from that described herein. The term encapsulated means encased in but not necessarily entirely encased without any exposure. Some external exposure is acceptable as long as the flexibility or bendable property of the molded plastic sheet material blanket is increased, i.e., the stiffness of the molded blanket plastic sheet material is decreased, by the encapsulation as compared to molded plastic sheet material with a liner that is not encapsulated. The disclosed embodiments are for illustration and not limitation. It is intended that the invention be defined by the appended claims.

What is claimed is:

1. A die cutter blanket assembly for use with a cylindrical anvil having a channel, the assembly comprising:
a die cutter plastic material sheet member having first and second ends;
a sheet metal liner bonded to the plastic sheet member and substantially encapsulated by the plastic material; and
a locking arrangement at the first and second ends for securing the blanket assembly to the anvil.

2. The assembly of claim 1 wherein the liner includes a plurality of upstanding projections.

3. The assembly of claim 2 wherein the projections are surrounded by the plastic material for substantially encapsulating the liner with the plastic material sheet member.

4. The assembly of claim 1 wherein the plastic sheet member is urethane.

5. The assembly of claim 2 wherein the projections are semispherical.

6. The assembly of claim 2 wherein the projections are dome shaped.

7. The assembly of claim 6 wherein the projections are about ⅝ inches (about 16 mm) in diameter at their junction with the liner.

8. The assembly of claim 6 wherein the projections are about 0.08 to about 0.09 inches in height above the plane of the sheet material of the liner.

9. The assembly of claim 2 wherein the projections are spaced apart center to center about two Inches (50 mm) in a plurality of parallel rows each row comprising a linear array of projections.

10. The assembly of claim 9 wherein the rows are spaced apart in the range of about two inches (about 50 mm) to about four inches (about 100 mm).

11. The assembly of claim 1 wherein the liner is about 0.017 to about 0.021 inches thick sheet steel.

12. The assembly of claim 1 wherein the locking arrangement includes a locking device for locking engagement with the anvil channel.

13. The assembly of claim 12 wherein the locking arrangement includes a projection which mates with the anvil channel for said locking engagement.

14. The assembly of claim 14 wherein the liner has opposite sides, the plastic material being present on both sides of the liner.

15. A method of making a die cutter blanket assembly for covering a rotatable cylindrical anvil of a die cutter apparatus comprising:
encapsulating a sheet metal blanket liner with a plastic material during the molding of a die cutter plastic sheet member having first and second ends, the molding for bonding the encapsulated liner to the plastic sheet member, and forming a locking arrangement at the first and second ends for locking the assembly to the anvil.

16. A die cutter blanket assembly for covering a rotatable anvil of a die cutter apparatus, the anvil having a channel therein, the assembly comprising:
a plastic material sheet member having first and second ends, the member for wrapping about the anvil such that the ends abut one another in the wrapped state to form a substantially continuous outer die cutting work surface about the anvil;
a sheet metal liner bonded contiguous to and overlying the plastic sheet member, the sheet metal liner having an array of spaced upstanding projections, the plastic material substantially encapsulating the liner with a plastic layer at least between the projections; and
a locking arrangement secured to the sheet material member at the first and second ends for securing the sheet material member and liner to the anvil.

17. The assembly of claim 16 wherein the plastic material is in the region between the projections on a side of the liner opposite said plastic sheet member for said encapsulation.
